(19) United States
(12) Patent Application Publication
(10) Pub. No.: US 2018/0154903 A1
(43) Pub. Date: Jun. 7, 2018

(54) ATTENTION MONITORING METHOD AND SYSTEM FOR AUTONOMOUS VEHICLES

(71) Applicant: Faraday&Future Inc., Gardena, CA (US)

(72) Inventor: Xiufeng Song, San Jose, CA (US)

(21) Appl. No.: 15/709,275

(22) Filed: Sep. 19, 2017

Related U.S. Application Data
(60) Provisional application No. 62/396,904, filed on Sep. 20, 2016.

(51) Int. Cl. B60W 40/08; B60W 50/12; G06K 9/00

(52) U.S. Cl. CPC B60W 40/08; B60W 2040/0818; G06K 9/00845; B60W 50/12

(57) ABSTRACT

An attention monitoring system is disclosed. The system may comprise a sensor configured to monitor a steering wheel of a vehicle, and a processor. The processor may be configured to determine if at least one hand is placed on the steering wheel based on the monitoring, and alert the vehicle's driver in response to determining that no hand is placed on the steering wheel. An autonomous driving function of the vehicle may be enabled.

### CROSS-REFERENCE TO RELATED APPLICATIONS

This application claims the benefit of U.S. Provisional Application No. 62/396,904, filed Sep. 20, 2016, the entirety of which is hereby incorporated by reference.

### TECHNICAL FIELD

The present disclosure relates generally to attention monitoring methods and systems, and more particularly, to attention monitoring methods and systems for autonomous vehicles.

### BACKGROUND

The U.S. Department of Transportation's National Highway Traffic Safety Administration (NHTSA) defines vehicle automation as having five levels:

No-Automation (Level 0): The driver is in complete and sole control of the primary vehicle controls—brake, steering, throttle, and motive power—at all times.

Function-specific Automation (Level 1): Automation at this level involves one or more specific control functions, such as electronic stability control or pre-charged brakes.

Combined Function Automation (Level 2): This level involves automation of at least two primary control functions designed to work in unison to relieve the driver of control of those functions, such as adaptive cruise control in combination with lane centering.

Limited Self-Driving Automation (Level 3): Vehicles at this level of automation enable the driver to cede full control of all safety-critical functions under certain traffic or environmental conditions and in those conditions to rely heavily on the vehicle to monitor for changes in those conditions requiring transition back to driver control. The driver is expected to be available for occasional control, but with sufficiently comfortable transition time.

Full Self-Driving Automation (Level 4): The vehicle is designed to perform all safety-critical driving functions and monitor roadway conditions for an entire trip. Such a design anticipates that the driver will provide destination or navigation input, but is not expected to be available for control at any time during the trip. This includes both occupied and unoccupied vehicles.

Therefore, except for the Level 4 vehicles, drivers' attention is still required for most autonomous vehicles. By paying at least some attention to the road, drivers can swiftly react to emergencies or other situations, for example, by taking over control of the vehicles. To prevent accidents and promote road safety, it is important to monitor drivers' attention and keep them alert, especially when some autonomous driving function has been enabled.

### SUMMARY

One aspect of the present disclosure is directed to an attention monitoring system. The system may comprise a sensor configured to monitor a steering wheel of a vehicle, and a processor. The processor may be configured to determine if at least one hand is placed on the steering wheel based on the monitoring result, and alert the vehicle's driver in response to determining that no hand is placed on the steering wheel. An autonomous driving function of the vehicle may be enabled.

Another aspect of the present disclosure is directed to an attention monitoring system. The system may comprise a sensor configured to monitor eyes of a vehicle driver, and a processor. The processor may be configured to determine if the driver's line of sight corresponds to the vehicle's moving direction, and alert the driver in response to determining that the driver's line of sight does not correspond to the vehicle's moving direction. An autonomous driving function of the vehicle may be enabled.

Another aspect of the present disclosure is directed to an attention monitoring method. The method may comprise enabling an Advanced Driver Assistance System (ADAS) of a vehicle, determining if at least one hand is placed on a steering wheel of the vehicle, alerting the vehicle's driver in response to determining that no hand is placed on the steering wheel, and disabling the ADAS after a hand is placed on the steering wheel.

Another aspect of the present disclosure is directed to an attention monitoring method. The method may comprise enabling an ADAS of a vehicle, determining if a line of sight of the vehicle's driver corresponds to the vehicle's moving direction, alerting the driver in response to determining that the line of sight of the vehicle's driver does not correspond to the vehicle's moving direction, and disabling the ADAS after the line of sight of the vehicle's driver turns to the vehicle's moving direction.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this disclosure, illustrate several embodiments and, together with the description, serve to explain the disclosed principles.

FIG. 1 is a graphical representation illustrating a vehicle for attention monitoring, consistent with exemplary embodiments of the present disclosure.

FIG. 2 is a block diagram illustrating a system for attention monitoring, consistent with exemplary embodiments of the present disclosure.

FIG. 3 is a flowchart illustrating a method for attention monitoring, consistent with exemplary embodiments of the present disclosure.

FIG. 4 is a flowchart illustrating a method for attention monitoring, consistent with exemplary embodiments of the present disclosure.

FIG. 5 is a flowchart illustrating a method for attention monitoring, consistent with exemplary embodiments of the present disclosure.

FIG. 6 is a flowchart illustrating a method for attention monitoring, consistent with exemplary embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention.

Existing autonomous vehicles may lack an alert or an ADAS disabling mechanism when drivers do not keep hands on the steering wheel, which may cause fatal accidents. The disclosed systems and methods may mitigate or overcome one or more of the problems set forth above and/or other problems in the prior art. The autonomous driving function or ADAS in this disclosure may refer to any system, device, or function that automates, adapts, or enhances vehicles, for example, any automatous or assistive function in autonomous vehicles described above. One or more parameters, such as time periods and thresholds, described herein are configurable.

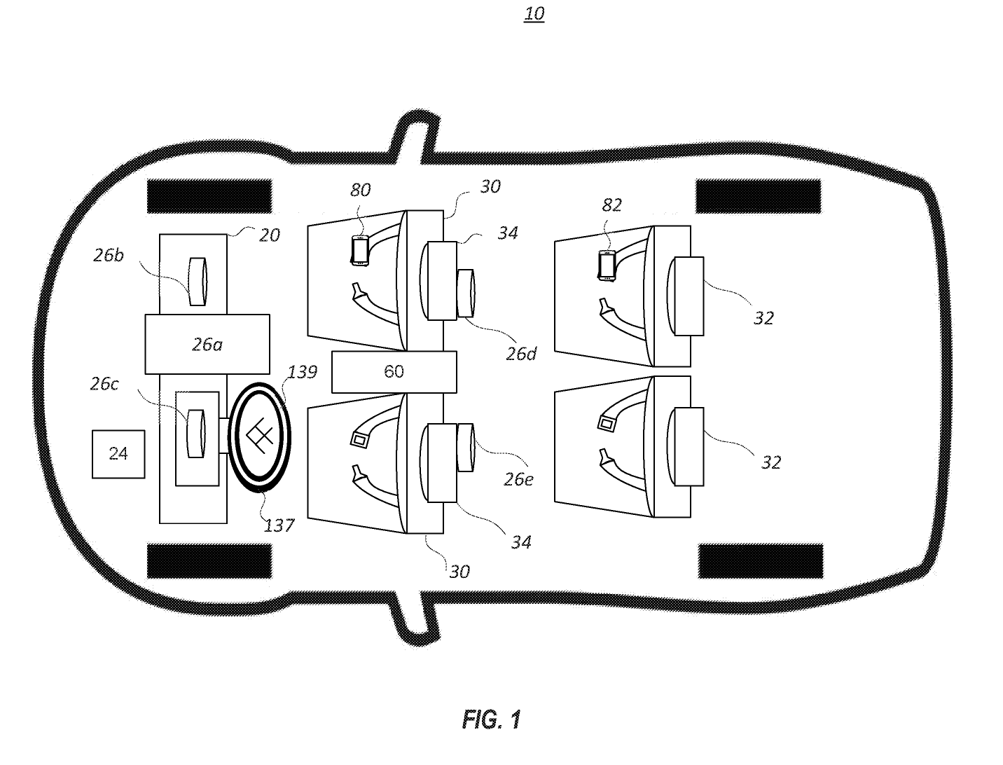

FIG. 1 is a graphical representation illustrating a vehicle 10 for attention monitoring, consistent with exemplary embodiments of the present disclosure. Vehicle 10 may have any body style of an automobile, such as a sports car, a coupe, a sedan, a pick-up truck, a station wagon, a sports utility vehicle (SUV), a minivan, or a conversion van. Vehicle 10 may also embody other types of transportation, such as motorcycles, boats, buses, trains, and planes. Vehicle 10 may be an electric vehicle, a fuel cell vehicle, a hybrid vehicle, or a conventional internal combustion engine vehicle. Vehicle 10 may be autonomous, e.g., Level 1-3 automation described above. In one example, vehicle 10 is a level 3 autonomous vehicle. Vehicle 10 may possess any autonomous driving function described above with reference to Level 1-3 automation.

As illustrated in FIG. 1, vehicle 10 may include a number of components, some of which may be optional. Vehicle 10 may have a dashboard 20 through which a steering wheel 137 and one or more user interfaces 26a-26c may project. Other user interfaces such as user interfaces 26d and 26e are described below. Any of the user interfaces may be referred to as user interface 26. Steering wheel 137 may include one or more sensors 139. For example, sensor 139 may be a touch sensor, a pressure sensor, or a temperature sensor disposed on a steering wheel and configured to monitor if a hand is placed on the wheel. Vehicle 10 may also have one or more front seats 30 and one or more back seats 32 configured to accommodate occupants. Vehicle 10 may also include a center console 60 disposed between front seats 30 or at another location of the vehicle. User interface 26 may include one or more sensors 36 configured to detect and recognize occupants and/or perform other functions as described below. Vehicle 10 may also include a detector and GPS unit 24 disposed in front of steering wheel 137, on the top of the vehicle, or at other locations to detect objects, receive signals (e.g., GPS signal), and/or transmit data. Detector and GPS unit 24 may determine in real time the location of vehicle 10 and/or information of the surrounding environment.

The positions of the various components of vehicle 10 in FIG. 1 are merely illustrative and are not limited as shown in the figure. For example, user interface 26 may include an infrared sensor disposed on a door next to an occupant, or a weight sensor embedded in a seat; user interface 26 can also be integrated with enter console 60; and detector and GPS unit 24 may be disposed at another position in the vehicle.

In some embodiments, user interface 26 may be configured to receive inputs from users or devices and transmit data. For example, user interface 26 may have a display including an LCD, an LED, a plasma display, or any other type of display, and provide a graphical user interface (GUI) presented on the display for user input and data display. User interface 26 may further include speakers or other voice playing devices. User interface 26 may further include input devices, such as a touchscreen, a keyboard, a mouse, a microphone, and/or a tracker ball, to receive a user input. User interface 26 may also connect to a network to remotely receive instructions or user inputs. Thus, the input may be directly entered by a current occupant, captured by interface 26, or received by interface 26 over the network. User interface 26 may further include a housing having grooves containing the input devices. User interface 26 may be configured to provide internet access, cell phone access, and/or in-vehicle network access, such as Bluetooth™, CAN bus, or any other vehicle bus architecture protocol that may be used to access features or settings within vehicle 10. User interface 26 may be further configured to display or broadcast other media, such as images, videos, and maps.

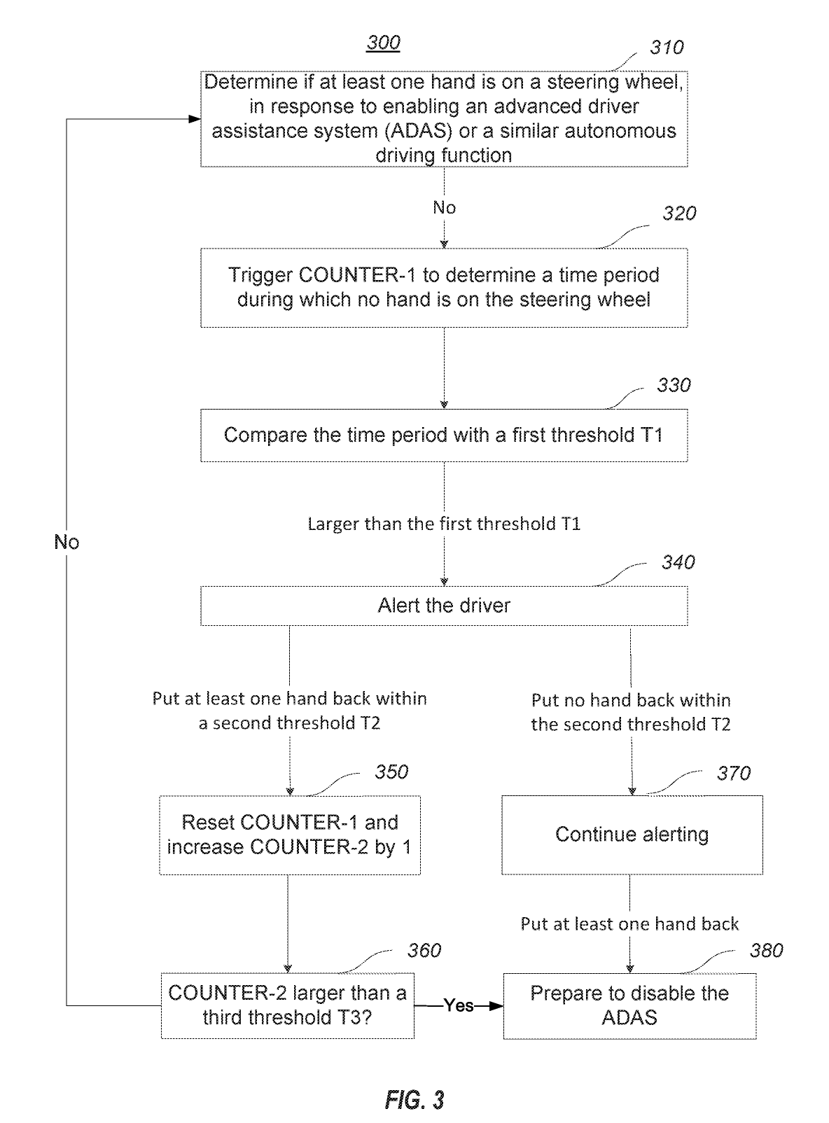

User interface 26 may also be configured to receive user-defined settings. For example, user interface 26 may be configured to receive occupant profiles including, for example, an age, a gender, a driving license status, an ADAS license status, an individual driving habit, a frequent destination, a store reward program membership, a frequently purchased item, favorite food, and etc. In some embodiments, user interface 26 may include a touch-sensitive surface configured to receive biometric data (e.g., detect a fingerprint of an occupant). The touch-sensitive surface may be configured to detect the ridges and furrows of a fingerprint based on a change in capacitance and generate a signal based on the detected fingerprint, which may be processed by an onboard computer described below with reference to FIG. 3. The onboard computer may be configured to compare the signal with stored data to determine whether the fingerprint matches any recognized occupant. The onboard computer may also be able to connect to the Internet, obtain data from the Internet, and compare the signal with obtained data to identify the occupants. User interface 26 may be configured to include biometric data into a signal, such that the onboard computer can identify the person generating an input. User interface 26 may also compare a received voice input with stored voices to identify the person generating the input. Furthermore, user interface 26 may be configured to store data history accessed by the identified person.

In some embodiments, sensor 36, as a component of user interface 26, may include one or more sensors, such as a camera, a microphone sound detection sensor, an infrared sensor, a weight sensor, a radar, an ultrasonic, a LIDAR sensor, or a wireless sensor. Sensor 36 may be configured to generate a signal to be processed to detect and/or recognize occupants of vehicle 10. In one example, sensor 36 may obtain identifications from occupants' cell phones. In another example, a camera 36 may be positioned on the back of a headrest 34 of a front seat 30 to capture images of an occupant in a back seat 32. In some embodiments, visually captured videos or images of the interior of vehicle 10 by camera 36 may be used in conjunction with an image recognition software, such that the software may distinguish a person from inanimate objects, may recognize the person based on physical appearances or traits, and may recognize body parts such as hands and eyes. The image recognition software may include a facial recognition software configured to match a captured occupant with stored profiles to identify the occupant. The image recognition software may also identify relative positions of the body parts in any space system, for example positions of the hands relative to a steering wheel, lines of sight of the eyes, and etc. In some embodiments, more than one sensor may be used in conjunction to detect and/or recognize the occupant(s). For example, sensor 36 may include a camera and a microphone, and captured images and voices may both work as filters to identify the occupant(s) based on the stored profiles. Similarly, LIDAR may perform the same function as the camera described above.

In some embodiments, sensor 36 may include one or more electrophysiological sensors for encephalography-based autonomous driving. For example, a fixed sensor 36 may detect electrical activities of brains of the occupant(s) and convert the electrical activities to signals, such that the onboard computer can control one or more components of vehicle 10 based on the signals. Sensor 36 may also be detachable and head-mountable, and may detect the electrical activities when worn by the occupant(s).

Vehicle 10 may be in communication with a plurality of mobile communication devices 80, 82. For example, mobile communication devices 80, 82 may include a smart phone, a tablet, a personal computer, a wearable device, such as a smart watch or Google Glass™, and/or complimentary components. Mobile communication devices 80, 82 may be configured to connect to a network, such as a nationwide cellular network, a local wireless network (e.g., Bluetooth™ or WiFi), and/or a wired network. Mobile communication devices 80, 82 may also be configured to access apps and websites of third parties, such as iTunes™, Pandora™, Google™, Facebook™, and Yelp™.

In some embodiments, mobile communication devices 80, 82 may be carried by or associated with one or more occupants in vehicle 10. For example, vehicle 10 may be configured to determine the presence of specific people based on a digital signature or other identification information from mobile communication devices 80, 82. For instance, an onboard computer may be configured to relate the digital signature to stored profile data including the person's name and the person's relationship with vehicle 10. The digital signature of mobile communication devices 80, 82 may include a determinative emitted radio frequency (RF) or a global positioning system (GPS) tag. Mobile communication devices 80, 82 may be configured to automatically connect to or be detected by vehicle 10 through local network 70, e.g., Bluetooth™ or WiFi, when positioned within a proximity (e.g., within vehicle 10).

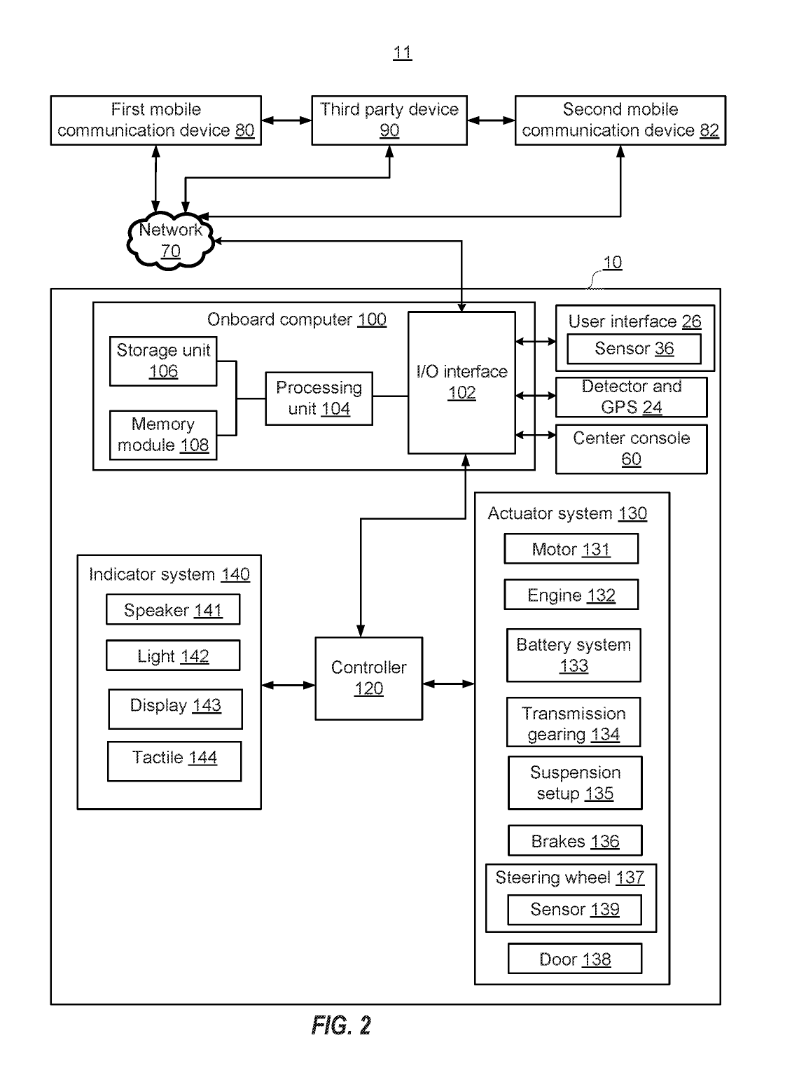

FIG. 2 is a block diagram illustrating a system 11 for attention monitoring, consistent with exemplary embodiments of the present disclosure. System 11 may include a number of components, some of which may be optional. As illustrated in FIG. 2, system 11 may include vehicle 10, as well as other external devices connected to vehicle 10 through network 70. The external devices may include mobile communication devices 80, 82, and third party device 90. Vehicle 10 may include a specialized onboard computer 100, a controller 120, an actuator system 130, an indicator system 140, a user interface 26, a detector and GPS unit 24, and a center console 60. User interface 26 may include one or more sensors 36. Onboard computer 100, actuator system 130, and indicator system 140 may all connect to controller 120. User interface 26, detector and GPS unit 24, and center console 60 may all connect to onboard computer 100. Onboard computer 100 may comprise, among other things, an I/O interface 102, a processing unit 104, a storage unit 106, a memory module 108. The above units of system 11 may be configured to transfer data and send or receive instructions between or among each other. Storage unit 106 and memory module 108 may be non-transitory and computer-readable and store instructions that, when executed by processing unit 104, cause system 11 or vehicle 10 to perform the methods described in this disclosure. Onboard computer 100 may be specialized to perform the methods and steps described below.

I/O interface 102 may include connectors for wires communications, wireless transmitters and receivers, and/or wireless transceivers for wireless communications. The connectors, transmitters/receivers, or transceivers may be configured for two-way communication between onboard computer 100 and various components of system 11, such as user interface 26, detector and GPS 24, and the external devices. I/O interface 102 may send and receive operating signals to and from mobile communication devices 80, 82 and third party devices 90. I/O interface 102 may send and receive the data between each of the devices via communication cables, wireless networks, or other communication mediums. For example, mobile communication devices 80, 82 and third party devices 90 may be configured to send and receive signals to I/O interface 102 via a network 70. Network 70 may be any type of wired or wireless network that may facilitate transmitting and receiving data. For example, network 70 may be a nationwide cellular network, a local wireless network (e.g., Bluetooth™ or WiFi), and/or a wired network.

Third party devices 90 may include smart phones, personal computers, laptops, pads, servers, and/or processors of third parties that provide access to contents and/or data (e.g., maps, traffic, store locations, weather, instruction, command, user input). Third party devices 90 may be accessible to the users through mobile communication devices 80, 82 or directly accessible by onboard computer 100, via I/O interface 102, according to respective authorizations of the user. For example, users may allow onboard computer 100 to receive third party contents by configuring settings of accounts with third party devices 90 or settings of mobile communication devices 80, 82.

Processing unit 104 may include one or more processors, and be configured to receive signals and process the signals to determine a plurality of conditions of the operation of vehicle 10, for example, operations of sensor 36 and operations of indicator system 140 through controller 120. Processing unit 104 may also be configured to generate and transmit command signals, via I/O interface 102, in order to actuate the devices in communication.

In some embodiments, processing unit 104 may be configured to determine the presence of people within an area, such as occupants of vehicle 10. Processing unit 104 may be configured to determine the identity of the occupants through a variety of mechanisms. For example, processing unit 104 may be configured to determine the presence of specific people based on a digital signature from mobile communication devices 80, 82. For instance, processing unit 104 may be configured to relate the digital signature to stored data including the person's name and the person's relationship with vehicle 10. The digital signature of communication device 80 may include a determinative emitted radio frequency (RF), GPS, Bluetooth™, or WiFi unique identifier. Processing unit 104 may also be configured to determine the presence of people within vehicle 10 by GPS tracking software of mobile communication devices 80, 82. In some embodiments, vehicle 10 may be configured to detect mobile communication devices 80, 82 when mobile communication devices 80, 82 connect to local network 70 (e.g., Bluetooth™ or WiFi).

In some embodiments, processing unit 104 may also be configured to recognize occupants of vehicle 10 by receiving inputs with user interface 26. For example, user interface 26 may be configured to receive direct inputs of the identities of the occupants. User interface 26 may also be configured to receive biometric data (e.g., fingerprints) from occupants when manipulating user interface 26. Processing unit 104 may be further configured to recognize occupants by facial recognition software used in conjunction with sensor 36.

In some embodiments, processing unit 104 may be configured to access and collect sets of data related to the people within the area in a number of different manners. Processing unit 104 may be configured to store the sets of data in a database. In some embodiments, processing unit 104 may be configured to access sets of data stored on mobile communication devices 80, 82, such as apps, audio files, text messages, notes, messages, photos, and videos. Processing unit 104 may also be configured to access accounts associated with third party devices 90, by either accessing the data through mobile communication devices 80, 82 or directly accessing the data from third party devices 90. Processing unit 104 may be configured to receive data directly from occupants, for example, through access of user interface 26. For example, occupants may be able to directly input vehicle settings, such as a desired internal temperature. Processing unit 104 may also be configured to receive data from history of previous inputs of the occupant into user interface 26.

Storage unit 106 and/or memory module 108 may be configured to store one or more computer programs that may be executed by onboard computer 100 to perform functions of system 11. For example, storage unit 106 and/or memory module 108 may be configured to store biometric data detection and processing software configured to determine the identity of people based on fingerprint(s), and store image recognition software configured to relate images to identities of people. Storage unit 106 and/or memory module 108 may be further configured to store data and/or look-up tables used by processing unit 104. For example, storage unit 106 and/or memory module 108 may be configured to include data related to individualized profiles of people related to vehicle 10. In some embodiments, storage unit 106 and/or memory module 108 may store the stored data and/or the database described in this disclosure.

Controller 120 is connected to one or more actuator systems 130 in the vehicle and one or more indicator systems 140 in the vehicle. One or more actuator systems 130 may include, but are not limited to, a motor 131 or engine 132, a battery system 133, a transmission gearing 134, a suspension setup 135, brakes 136, a steering wheel 137, and a door system 138. Some of these components may be optional. For example, an electric vehicle may not include engine 132. Steering wheel 137 may include one or more sensors 139. For example, sensor 139 may be a touch sensor, a pressure sensor, or a temperature sensor disposed on a steering wheel and be configured to monitor if a hand is placed on the wheel. The onboard computer 100 can control, via controller 120, one or more of these actuator systems 130 during vehicle operation, for example, to open or close one or more of the doors of the vehicle using the door actuator system 138, to control the vehicle during autonomous driving or parking operations, and etc.

One or more indicator systems 140 may include, but are not limited to, one or more speakers 141 in the vehicle (e.g., as part of an entertainment system in the vehicle or part of user interface 26), one or more lights 142 in the vehicle, one or more displays 143 in the vehicle (e.g., as part of a control or entertainment system in the vehicle), and one or more tactile actuators 144 in the vehicle (e.g., as part of a steering wheel or seat in the vehicle). Display 143 may include a touch screen/display that provides an interactive interface.

FIG. 3 is a flowchart illustrating a method 300 for attention monitoring, consistent with exemplary embodiments of the present disclosure. Method 300 may include a number of steps and sub-steps, some of which may be optional. The steps or sub-steps may also be rearranged in another order. Method 300 may monitor a driver's hands.

In Step 310, one or more components of system 10 or 11 may determine if at least one hand is placed on a steering wheel, in response to enabling an ADAS or a similar autonomous driving function. For example, when the ADAS or a similar autonomous driving function is enabled on the vehicle 10, processing unit 104 may determine if at least one hand is placed on steering wheel 137. If the determination is yes, processing unit 104 may continue monitoring the hand position. If the determination is no, method 300 proceeds to step 320.

There may be many methods for determining the at least one hand on the steering wheel. For example, processing unit 104 may receive signals from sensor 139 described above via an embedded control unit (ECU) in the steering wheel 137 to monitor the at least one hand. Sensor 139 may be a touch sensor covering at least a portion of steering wheel 137. If a hand is placed on steering wheel 137, it may trigger a signal from sensor 139, which can be captured by the ECU and processing unit 104.

For another example, processing unit 104 may receive signals from sensor 36 described above to monitor the at least one hand. Sensor 36 may be integrated with any user interface 26 or may be disposed at another location of the the vehicle as long as it can monitor the steering wheel area. Sensor 36 may be, for example, a camera or a LIDAR. The camera may continuously capture images of steering wheel 137, which are transmitted to processing unit 104. Similarly, the LIDAR may continuously scan steering wheel 137, and corresponding scanning results are transmitted to processing unit 104. Processing unit 104 may execute related programs, such as an image recognition program or a hand scanning program, to recognize one or more hand and determine if at least one hand is placed on steering wheel 137.

In Step 320, one or more components of system 10 or 11 may trigger a first counter COUNTER-1 to determine a time period during which no hand is placed on the steering wheel. For example, processing unit 104 may start a timer if it determines that no hand is on the wheel. In some embodiments, processing unit 104 may determine an identity of a driver, for example, through image recognition, weight recognition, or etc. Consequently, processing unit 104 may obtain features of the driver's hand(s), for example, by retrieving the features from stored profiles or directly capturing the features from sensor 139. The features may be unique to the driver, such as fingerprints or palm prints. Thus, processing unit 104 can distinguish and monitor the driver's hand(s) for method 300. That is, in Step 310, it may be determined whether at least one of the driver's hands is on the steering wheel, and in Step 320, the first counter may be triggered to determine a time period during which none of the driver's hands is on the steering wheel.

In Step 330, one or more components of system 10 or 11 may compare the time period with a first threshold with T1. If the time period is over the first threshold, method 300 may proceed to Step 340; otherwise; processing unit 104 may continue monitoring the at least one hand. For example, if processing unit 104 determines in Step 320 that no hand is placed on the steering wheel for 11 seconds, it may compare the determined 11 seconds with a 10 seconds threshold of T1. Since 11 seconds is over the 10 seconds threshold, method 300 may proceed to Step 340.

In Step 340, one or more components of system 10 or 11 may alert the driver. For example, processing unit 104 may display or broadcast a warning message through user interface 26. The warning message may inform the driver that at least one hand should be placed on the wheel. The warning message may also notify a potential switch-off of the ADAS system if the driver does not comply. Complying may refer to putting at least one hand back to the steering wheel within a second threshold T2. If the driver complies, method 300 may proceed to Step 350; otherwise, method 300 may proceed to Step 370.

In Step 350, one or more components of system 10 or 11, e.g., processing unit 104, may reset the first counter and increase a second counter COUNTER-2 by 1. The second counter may record a number of times that the driver puts hands away from the steering wheel for a time period over T1.

In Step 360, one or more components of system 10 or 11, e.g., processing unit 104, may determine if the second counter is larger than a third threshold T3. If the determination is yes, method 300 may proceed to Step 380. If the determination is no, method 300 may proceed back to Step 310, where processing unit 104 continues monitoring the at least one hand.

In Step 370, one or more components of system 10 or 11, e.g., processing unit 104, may continue alerting the driver, until the driver puts at least one hand back to the steering wheel. Step 370 may not proceed to Step 380 if no hand is put on the wheel, to ensure that the vehicle is in control after an ADAS switch-off.

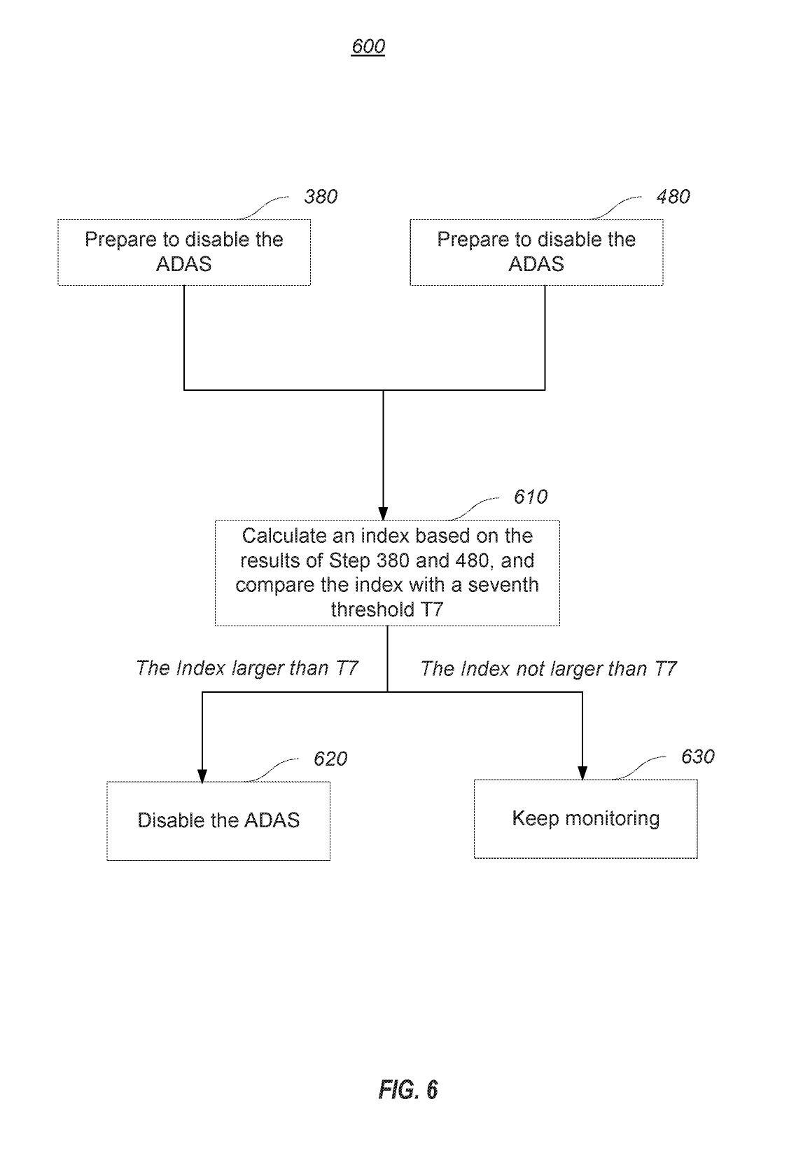

In Step 380, one or more components of system 10 or 11, e.g., processing unit 104, may prepare to disable the ADAS or the autonomous driving function. Preparing to disable the ADAS may include disabling the ADAS as described in the following examples, or proceeding for further evaluation as described below with reference to FIG. 6. In one example, the processing unit 104 may monitor whether the vehicle is under full control of the driver, e.g., by monitoring whether the driver is turning the steering wheels via sensor 139. If the processing unit 104 determines that the driver is controlling the vehicle, the processing unit 104 may disable the ADAS. In another example, before disable ADAS, the processing unit 104 may play a message via interface 26 that ADAS is going to be disabled, and request the driver to acknowledge the message, e.g., by touching a button on interface 26 or by saying “yes,” which can be captured by a microphone coupled to the processing unit 104. Alternatively, processing unit 104 may disable the ADAS or the autonomous driving function at this step. If the ADAS is disabled, one or more autonomous driving functions may be paused or switched off.

As described above with reference to method 300 and corresponding devices, the disclosed vehicle can monitor hand positions of a driver when the ADAS is turned on, and warn the driver if he does not place at least one hand on the steering wheel for a certain period of time. By keeping at least one hand on the wheel, the driver can respond more quickly to road situations and avoid potential accidents.

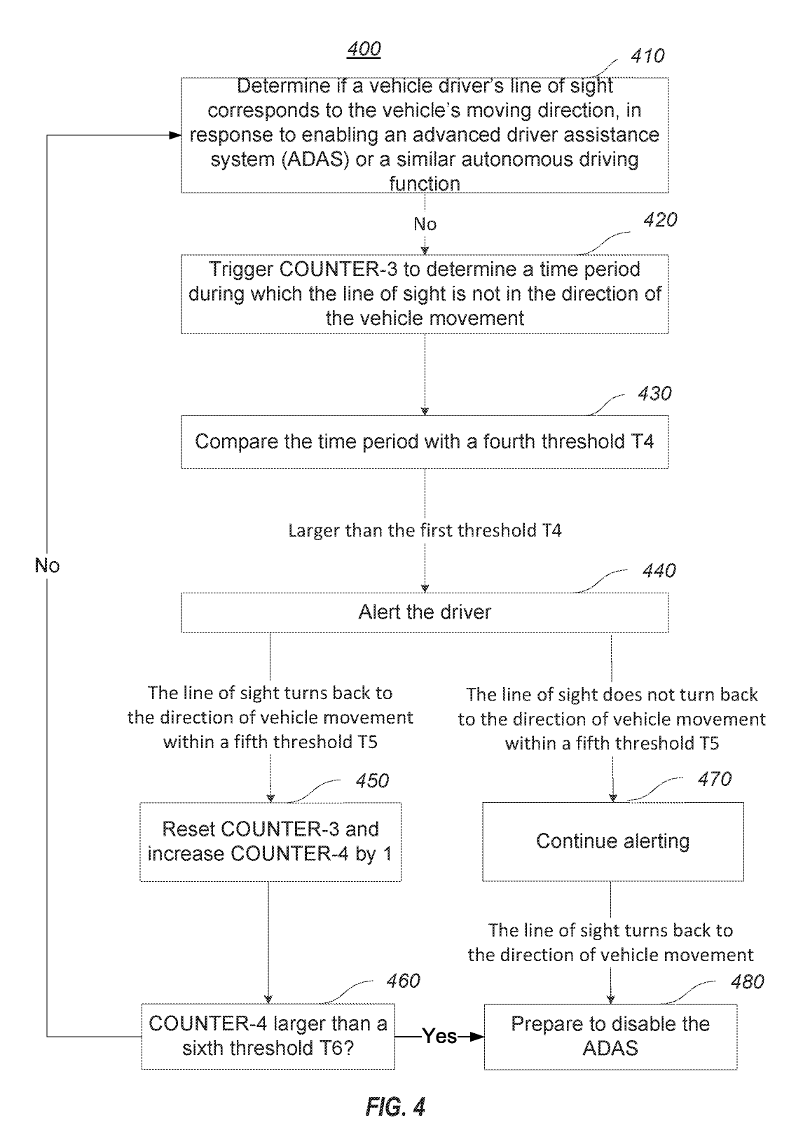

FIG. 4 is a flowchart illustrating a method 400 for attention monitoring, consistent with exemplary embodiments of the present disclosure. Method 400 may include a number of steps and sub-steps, some of which may be optional. The steps or sub-steps may also be rearranged in another order. Method 400 may monitor a driver's view.

In Step 410, one or more components of system 10 or 11 may determine if a vehicle driver's line of sight corresponds to the vehicle's moving direction, in response to enabling an ADAS. For example, when the ADAS of a vehicle is enabled, processing unit 104 may determine if the line of sight of the vehicle's driver corresponds to the direction of the vehicle's motion. If the determination is yes, processing unit 104 may continue monitoring the eyes. If the determination is no, method 400 proceeds to step 420.

There may be many methods of determining if the driver's line of sight corresponds to the vehicle's moving direction. For example, processing unit 104 may receive signals from sensor 36 described above to monitor the driver's line of sight, and sensor 36 may be, for example, a camera or a LIDAR. Sensor 36 may be disposed on the dashboard and may monitor the driver's eyes. For example, sensor 36 may track eyeball movements and pupil positions, and determine a corresponding line of sight of the driver. Processing unit 104 may also determine the moving direction of the vehicle by, for example, tracking the vehicle's position with respect to time or the wheel status. For another example, processing unit 104 may determine the vehicle's moving direction based on vehicle alignment, such as the steering wheel's alignment, and the configuration of gear selector lever (e.g., whether the car is on “D” (Drive) or “R” (Reverse)). Accordingly, processing unit 104 may compare the driver's line of sight with the moving direction. If the difference between the driver's line of sight and the moving direction is less than a threshold, e.g., the angle between the line of sight and the moving direction is less than 10 degrees in a horizontal plane, processing unit 104 may determine that the line of sight is in the moving direction. Otherwise, processing unit 104 may determine that the line of sight is not in the moving direction, and method 400 may proceed to Step 420.

In Step 420, one or more components of system 10 or 11 may trigger a third counter COUNTER-3 to determine a time period during which the line of sight is not in the direction of the vehicle's movement. For example, processing unit 104 may start a timer if it determines that the line of sight is not in the moving direction. In some embodiments, processing unit 104 may determine an identity of the driver, for example, through iris recognition, and monitor only the driver's eyes.

In Step 430, one or more components of system 10 or 11 may compare the time period with a fourth threshold with T4. If the time period is over the fourth threshold, method 400 may proceed to Step 440; otherwise; processing unit 104 may continue monitoring the light of sight. For example, if processing unit 104 determines in Step 420 that the light of sight is not in the moving direction for 15 seconds, it may compare the determined 15 seconds with a 12 seconds threshold of T4. Since 15 seconds is over the 12 seconds threshold, method 400 may proceed to Step 440.

In Step 440, one or more components of system 10 or 11 may alert the driver. For example, processing unit 104 may display or broadcast a warning message through user interface 26. The warning message may inform the driver to look in the direction of the vehicle's movement. The warning message may also notify a potential switch-off of the ADAS system if the driver does not comply. Complying may refer to turning the line of sight back to the vehicle's moving direction within a fifth threshold T5. If the driver complies, method 400 may proceed to Step 450; otherwise, method 400 may proceed to Step 470.

In Step 450, one or more components of system 10 or 11, e.g., processing unit 104, may reset the third counter and increase a fourth counter COUNTER-4 by 1. The fourth counter may record a number of times that the driver's line of sight turns away from the vehicle's moving direction (e.g., the line of sight not in the moving direction) for a time period over T4.

In Step 460, one or more components of system 10 or 11, e.g., processing unit 104, may determine if the fourth counter is larger than a sixth threshold T6. If the determination is yes, method 400 may proceed to Step 480. If the determination is no, method 400 may proceed back to Step 410, where processing unit 104 continues monitoring the eyes.

In Step 470, one or more components of system 10 or 11, e.g., processing unit 104, may continue alerting the driver, until the driver turns the line of sight to the vehicle's moving direction. This step may be optional.

In Step 480, one or more components of system 10 or 11, e.g., processing unit 104, may prepare to disable the ADAS or the autonomous driving function. Preparing to disable the ADAS may include disabling the ADAS as described in the following examples, or proceeding for further evaluation as described below with reference to FIG. 6. In one example, the processing unit 104 may monitor whether the vehicle is under full control of the driver, e.g., by monitoring whether the driver is turning the steering wheels via sensor 139. If the processing unit 104 determines that the driver is controlling the vehicle, the processing unit 104 may disable the ADAS. In another example, before disable ADAS, the processing unit 104 may play a message via interface 26 that ADAS is going to be disabled, and request the driver to acknowledge the message, e.g., by touching a button on interface 26 or by saying “yes,” which can be captured by a microphone coupled to the processing unit 104. Alternatively, processing unit 104 may disable the ADAS or the autonomous driving function at this step. If the ADAS is disabled, one or more autonomous driving functions may be paused or switched off.

As described above with reference to method 400 and corresponding devices, the disclosed vehicle can monitor the line of sight of a driver when the ADAS is turned on, and warn the driver if he looks away from the vehicle's moving direction over a time threshold. By keeping the eyes on the road, drivers can respond more quickly to various situations and avoid potential accidents.

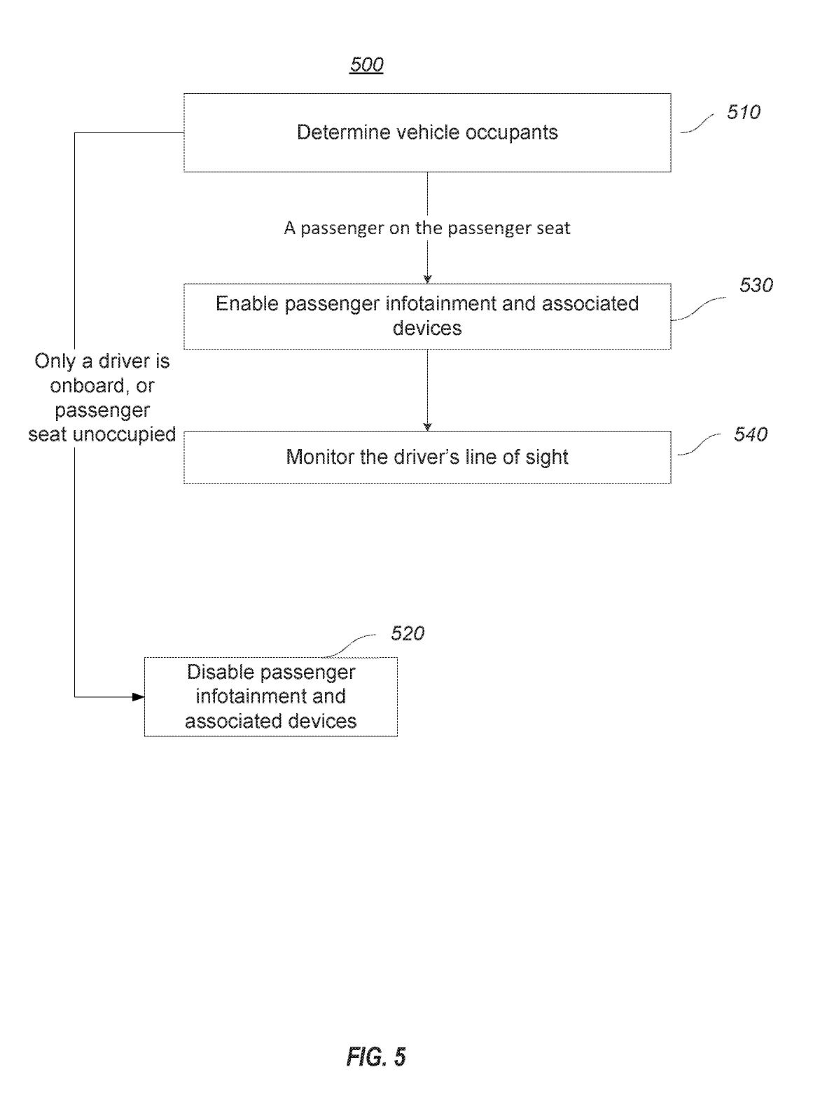

FIG. 5 is a flowchart illustrating a method 500 for attention monitoring, consistent with exemplary embodiments of the present disclosure. Method 500 may include a number of steps and sub-steps, some of which may be optional. The steps or sub-steps may also be rearranged in another order. Method 500 may control an infotainment system of the vehicle.

In Step 510, one or more components of system 10 or 11 may determine one or more vehicle occupants onboard of vehicle 10. For example, user interface 26 and processing unit 104 may monitor one or more occupants in the vehicle, through various sensing methods, such as image sensing or weight sensing, described above. If it is determined that only a driver is onboard or a passenger seat is unoccupied, method 500 may proceed to Step 520. Here the passenger seat may refer to the front row seat next to the driver's seat. If it is determined that a passenger is on the passenger seat, method 500 may proceed to Step 530.

At Step 520, one or more components of system 10 or 11 may disable passenger infotainment and associated devices. The infotainment may refer to information and entertainment systems. The passenger infotainment may be associated with one or more devices and functions. For example, user interface 26b may be disabled for all functions. For another example, user interface 26a may be disabled for playing movies and limited to navigation and vehicle control.

At Step 530, one or more components of system 10 or 11 may enable the passenger infotainment and associated devices. For example, user interface 26b may be enabled for all functions, and user interface 26a may be enabled for playing movies.

At Step 540, one or more components of system 10 or 11 may monitor the drive's line of sight. This step may be similar to method 400 described above to ensure that the driver is not distracted by the infotainment system. For example, if processing unit 104 determines that the driver's line of sight is directed to the infotainment system, it may trigger an alert.

As described by method 500 and corresponding devices, the disclosed vehicle can restrict functionalities of the onboard infotainment system according to the vehicle occupant determination. Such restriction can help prevent the driver from being distracted by infotainment contents.

FIG. 6 is a flowchart illustrating a method 600 for attention monitoring, consistent with exemplary embodiments of the present disclosure. Method 600 may include a number of steps and sub-steps, some of which may be optional. The steps or sub-steps may also be rearranged in another order. Method 600 may continue from Step 380 of method 300 and Step 480 of method 400 described above to holistically evaluate all parameters before disabling the ADAS. In some other embodiments, method 600 is entirely optional, and Step 380 may end method 300 by disabling the ADAS, and Step 480 may end method 400 by disabling the ADAS.

In Step 610, one or more components of system 10 or 11 may calculate an index based on the results of Step 380 and Step 480, and compare the index with a seventh threshold T7. In some embodiments, processing unit 104 may holistically calculate the index. The calculation and T7 may be configurable. For example, COUNTER-2 over T3 may be given an index value of 3, COUNTER-4 over T6 may be given an index value of 5, the index may be a sum of COUNTER-2 index value and COUNTER-4 index value, and T7 may be 4. In this example, the ADAS would be disabled if the COUNTER-4 is over T6 (that is, having an index of 5, which is over T7) or if COUNTER-4 over T6 and COUNTER-2 is over T3 (that is, having an index of 5+3, which is also over T7), but not when only COUNTER-2 is over T3 (that is, having an index of 3, which is below T7). This example may describe a configuration of which the line of sight is a more important than the hand position in disabling the ADAS. Similarly, other parameters may also be included in calculating the index.

If the index is larger than T7 (that is, over the configured limit for enabling autonomous driving while ensuring safety), method 600 may proceed to Step 620, where one or more components of system 10 or 11, e.g., processing unit 104, may disable the ADAS.

If the index is not larger than T7 (that is, within the configured limit for allowing autonomous driving while ensuring safety), method 600 may proceed to Step 630, where one or more components of system 10 or 11, e.g., processing unit 104, may continue monitoring, e.g., by performing Step 310 and/or Step 410.

In some embodiments, to implement methods 400, 500, and/or 600, vehicle 10 may detect a number of occupants in vehicle 10 and their identities, and determine their associated voices, finger prints, images, gestures, and etc. For example, sensor 36 may include a cellphone detection sensor that detect the occupants according to mobile communication devices 80, 82 connected to a local wireless network (e.g., Bluetooth™) of vehicle 10, and transmit the detected number to processing unit 104. For another example, user interface 26 may detect the occupants according to manual entry of data into vehicle 10, e.g., occupants selecting individual names through user interface 26, and transmit the detected number to processing unit 104. Processing unit 104 may also collect biometric data (e.g., fingerprint data) from the occupants through user interface 26. For another example, sensor 36 may include cameras that capture images of occupants, microphones that capture voices of occupants, and/or weight sensors that capture weights of objects on the vehicle seats. Based on the received data from these sensors, processing unit 104 may determine each occupant in vehicle 10.

In some embodiments, one or components of system 11 may determine each occupant's identity, by executing a software such as an image recognition software, a voice recognition software, or a weight recognition software, based on the received data from sensor 36 and/or user interface 26. For example, sensor 36 may detect a digital signature or other identification information from mobile communication devices that occupants carry, and processing unit 104 may determine the occupants' identifies based on the digital signatures. Processing unit 104 may access, collect, and update sets of data related to each occupant in vehicle 10. Processing unit 104 may determine whether the determined occupants have stored profiles. Processing unit 104 may also access sets of data stored on mobile communication device 80, 82 and third party devices 90 to update the stored profile(s). If an occupant does not have a stored profile, processing unit 104 may generate a profile based on the accessed data. Each profile may include information such as age, gender, driving license status, driving habit, frequent destination, favorite food, shopping habit, enrolled store reward program, and the associated item(s). Based on the combination of the sensor input and the stored profiles, processing unit 104 can determine each occupant's unique voice, finger print, images, gesture, and etc. With the occupants identified, monitoring targets of methods described above can be more accurately determined.

In some embodiments, the above-described systems and methods can be applied to vehicles in a platoon. Vehicles traveling in a platoon may travel in a formation with small separations, and accelerate and brake together. The disclosed systems and methods can help platoon vehicle drivers to maintain a required level of attention, especially during platoon joining and exiting stages.

Another aspect of the disclosure is directed to a non-transitory computer-readable medium storing instructions which, when executed, cause one or more processors to perform the method, as discussed above. The computer-readable medium may include volatile or non-volatile, magnetic, semiconductor, tape, optical, removable, non-removable, or other types of computer-readable storage medium or computer-readable storage devices. For example, the computer-readable medium may be the storage unit or the memory module having the computer instructions stored thereon, as disclosed. In some embodiments, the computer-readable medium may be a disc or a flash drive having the computer instructions stored thereon.

A person skilled in the art can further understand that, various exemplary logic blocks, modules, circuits, and algorithm steps described with reference to the disclosure herein may be implemented as specialized electronic hardware, computer software, or a combination of electronic hardware and computer software. For examples, the modules/units may be implemented by one or more processors to cause the one or more processors to become one or more special purpose processors to executing software instructions stored in the computer-readable storage medium to perform the specialized functions of the modules/units.

The flowcharts and block diagrams in the accompanying drawings show system architectures, functions, and operations of possible implementations of the system and method according to multiple embodiments of the present invention. In this regard, each block in the flowchart or block diagram may represent one module, one program segment, or a part of code, where the module, the program segment, or the part of code includes one or more executable instructions used for implementing specified logic functions. It should also be noted that, in some alternative implementations, functions marked in the blocks may also occur in a sequence different from the sequence marked in the drawing. For example, two consecutive blocks actually can be executed in parallel substantially, and sometimes, they can also be executed in reverse order, which depends on the functions involved. Each block in the block diagram and/or flowchart, and a combination of blocks in the block diagram and/or flowchart, may be implemented by a dedicated hardware-based system for executing corresponding functions or operations, or may be implemented by a combination of dedicated hardware and computer instructions.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware for allowing specialized components to perform the functions described above. Furthermore, embodiments of the present disclosure may take the form of a computer program product embodied in one or more tangible and/or non-transitory computer-readable storage media containing computer-readable program codes. Common forms of non-transitory computer readable storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Embodiments of the present disclosure are described with reference to flow diagrams and/or block diagrams of methods, devices (systems), and computer program products according to embodiments of the present disclosure. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a computer, an embedded processor, or other programmable data processing devices to produce a special purpose machine, such that the instructions, which are executed via the processor of the computer or other programmable data processing devices, create a means for implementing the functions specified in one or more flows in the flow diagrams and/or one or more blocks in the block diagrams.

These computer program instructions may also be stored in a computer-readable memory that can direct a computer or other programmable data processing devices to function in a particular manner, such that the instructions stored in the computer-readable memory produce a manufactured product including an instruction means that implements the functions specified in one or more flows in the flow diagrams and/or one or more blocks in the block diagrams.

These computer program instructions may also be loaded onto a computer or other programmable data processing devices to cause a series of operational steps to be performed on the computer or other programmable devices to produce processing implemented by the computer, such that the instructions (which are executed on the computer or other programmable devices) provide steps for implementing the functions specified in one or more flows in the flow diagrams and/or one or more blocks in the block diagrams. In a typical configuration, a computer device includes one or more Central Processing Units (CPUs), an input/output interface, a network interface, and a memory. The memory may include forms of a volatile memory, a random access memory (RAM), and/or non-volatile memory and the like, such as a read-only memory (ROM) or a flash RAM in a computer-readable storage medium. The memory is an example of the computer-readable storage medium.

The computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The computer-readable medium includes non-volatile and volatile media, and removable and non-removable media, wherein information storage can be implemented with any method or technology. Information may be modules of computer-readable instructions, data structures and programs, or other data. Examples of a non-transitory computer-readable medium include but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices, a cache, a register, or any other non-transmission media that may be used to store information capable of being accessed by a computer device. The computer-readable storage medium is non-transitory, and does not include transitory media, such as modulated data signals and carrier waves.

The specification has described attention monitoring methods, apparatus, and systems for autonomous vehicles. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with the disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. An attention monitoring system, comprising:
a sensor configured to monitor a steering wheel of a vehicle, wherein an autonomous driving function of the vehicle is enabled; and
a processor configured to:
determine if at least one hand is placed on the steering wheel based on the monitoring; and
alert the vehicle's driver in response to determining that no hand is placed on the steering wheel.

2. The system of claim 1, wherein the sensor comprises a touch sensor on the steering wheel.

3. The system of claim 1, wherein the sensor comprises a camera.

4. The system of claim 1, wherein the autonomous driving function is an Advanced Driver Assistance System (ADAS) function.

5. The system of claim 1, wherein to alert the driver based on the determination, the processor is configured to:
trigger a first counter to determine a time period during which no hand is on the steering wheel;
compare the time period with a first time threshold; and
alert the driver in response to determining that the time period is over the first time threshold.

6. The system of claim 1, wherein the processor is further configured to reset the first counter and increase a second counter by one, in response to determining that at least one hand is placed on the steering wheel within a second time threshold after the alert.

7. The system of claim 6, wherein the processor is further configured to disable the autonomous driving function, in response to determining that the second counter is over a third threshold.

8. The system of claim 1, wherein the processor is further configured to continue alerting the driver, in response to determining that no hand is placed on the steering wheel within a second time threshold after the alert.

9. The system of claim 8, wherein the processor is further configured to disable the autonomous driving function, after determining that at least one hand is placed on the steering wheel in response to the continued alert.

10. An attention monitoring system, comprising:
a sensor configured to monitor eyes of a vehicle driver, wherein an autonomous driving function of the vehicle is enabled; and
a processor configured to:
determine if the driver's line of sight corresponds to the vehicle's moving direction; and
alert the driver in response to determining that the driver's line of sight does not correspond to the vehicle's moving direction.

11. The system of claim 10, wherein the sensor comprises a camera.

12. The system of claim 10, wherein the sensor comprises a LIDAR.

13. The system of claim 10, wherein the autonomous driving function is an Advanced Driver Assistance System (ADAS) function.

14. The system of claim 10, wherein to alert the driver based on the determination, the processor is configured to:
trigger a third counter to determine a time period during which the line of sight does not correspond to the vehicle's moving direction;
compare the time period with a fourth time threshold; and
alert the driver in response to determining that the time period is over the fourth time threshold.

15. The system of claim 10, wherein the processor is further configured to reset the third counter and increase a fourth counter by one, in response to determining that the line of sight turns to the vehicle's moving direction within a fifth time threshold after the alert.

16. The system of claim 15, wherein the processor is further configured to disable the autonomous driving function, in response to determining that the fourth counter is over a sixth time threshold.

17. The system of claim 10, wherein the processor is further configured to continue alerting the driver, in response to determining that the line of sight does not turn to the vehicle's moving direction within a fifth time threshold after the alert.

18. The system of claim 17, wherein the processor is further configured to disable the autonomous driving function of the vehicle, after determining that the line of sight turns back to the vehicle's moving direction in response to the continued alert.

19. An attention monitoring method, comprising:
enabling an Advanced Driver Assistance System (ADAS) of a vehicle;
determining if at least one hand is placed on a steering wheel of the vehicle;
alerting the vehicle's driver in response to determining that no hand is placed on the steering wheel; and
disabling the ADAS after a hand is placed on the steering wheel.
